(19) United States
(12) Patent Application Publication
(10) Pub. No.: US 2008/0109646 A1
(43) Pub. Date: May 8, 2008

(54) DATA PROCESSING APPARATUS FOR LOOP STRUCTURE AND METHOD THEREOF

(75) Inventors: Ching-Min Hou, Taichung County (TW); Kung-Hsien Chu, Chiayi County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: ITE TECH. INC., Hsinchu (TW)

(21) Appl. No.: 11/624,222

(22) Filed: Jan. 18, 2007

(30) Foreign Application Priority Data
Nov. 8, 2006 (TW) 95141290

(51) Int. Cl. G06F 9/38

(52) U.S. Cl. 712/241; 712/E09.058

(57) ABSTRACT

A data processing apparatus for loop structure is provided. The apparatus includes a fast memory device and a loop detector. The loop detector is coupled to a processor to detect whether the processor performs a loop structure or not. When the processor performs the loop structure, the loop detector outputs a control signal. According to the control signal, the apparatus stores a loop structure data corresponding to the loop structure in the fast memory device for the processor to perform the loop structure.

### CROSS-REFERENCE TO RELATED APPLICATION

This application claims the priority benefit of Taiwan application serial no. 95141290, filed on Nov. 8, 2006. All disclosure of the Taiwan application is incorporated herein by reference.

### BACKGROUND OF THE INVENTION

1. Field of the Invention

The present invention relates to a data processing apparatus for loop structure, and more particularly to a data processing apparatus for loop structure capable of improving the loop structure speed of the processor and enhancing the overall operational performance of the system and the processing method thereof.

2. Description of Related Art

An electronic system usually includes a processor and a memory, wherein a nonvolatile memory can still hold program instructions and/or data of the processor without power source. The nonvolatile memory consumes relatively small power, and unlike magnetic storage media such as hard discs, the nonvolatile memory will not be easily influenced by the vibration, and thus it is widely used in digital audio-visual devices, electronic equipments, portable computers, and digital cameras. Therefore, the nonvolatile memory such as a flash memory is typically used to store firmware or used as a basic input/output system (BIOS) memory.

However, the data reading/writing speed of the flash memory is usually slower than the data processing speed of the processor, and especially the data reading/writing speed of a series flash is far lower than the data processing speed of the processor. Therefore, when the processor performs the loop structure, the operational performance is greatly reduced as the data reading of the flash memory takes a long time, which further affects the overall operational performance of the system.

### SUMMARY OF THE INVENTION

In view of the above problems, the present invention provides a data processing apparatus for loop structure for enhancing the operational performance of the processor. When the processor is required to perform the loop structure, the loop structure data corresponding to the loop structure is stored in a fast memory device for the processor to perform the loop structure, thereby improving the loop structure speed of the processor and enhancing the overall operational performance of the system.

The present invention further provides a method for processing a loop structure data to avoid delaying the reading of data and affecting the operational performance of the processor. When the processor executes the loop structure, the loop structure data corresponding to the loop structure is stored in the fast memory device for the processor to perform the loop structure, thereby improving the loop structure speed of the processor and enhancing the overall operational performance of the system.

In order to achieve the above and other aspects, a data processing apparatus for loop structure comprising a fast memory device and a loop detector is provided. The loop detector is coupled to the processor for detecting whether or not the processor performs a loop structure. When the processor performs the loop structure, the loop detector outputs a control signal, and the data processing apparatus for loop structure stores the loop structure data corresponding to the loop structure in the fast memory device for the processor to perform the loop structure according to the control signal.

According to a preferred embodiment of the present invention, the data processing apparatus for loop structure further comprises a multiplexer. The multiplexer is coupled to the fast memory device and slow memory device, and one of the fast memory device and the slow memory device is selected according to the control signal so as to provide the loop structure data to the processor. When the processor performs the loop structure, if the fast memory device has the loop structure data, the fast memory device provides the loop structure data to the processor, whereas if the fast memory device does not store the loop structure data, the slow memory device provides the loop structure data to the processor and then duplicates the loop structure data into the fast memory device.

According to a preferred embodiment of the present invention, the processor is an 8051 microprocessor or 8086 microprocessor. The loop data processing apparatus of the present invention determines whether or not the processor requires the loop data according to the program code in the processor, and then stores the corresponding loop data in the fast memory device, for example, a static random access memory (SRAM) or a dynamic random access memory (DRAM). The above slow memory device comprises, for example, a flash memory.

According to an aspect of the present invention, a method for processing the loop structure data is provided. The method comprises detecting whether or not the processor performs the loop structure, and when it is determined that the processor performs the loop structure, the loop structure data corresponding to the loop structure is stored in a fast memory device for the processor to perform the loop structure.

According to a preferred embodiment of the present invention, the fast memory device provides the loop structure data to the processor when the fast memory device has the loop structure data by, and the slow memory device provides the loop structure data to the processor and duplicates the loop structure data into the fast memory device when the fast memory device does not store the loop structure data.

The present invention utilizes the loop detector to detect whether or not the processor performs the loop structure. When it is determined that the processor performs the loop structure, the loop detector outputs a control signal, and according to the control signal, the data processing apparatus for loop structure stores the loop structure data corresponding to the loop structure in the fast memory device for the processor to perform the loop structure. Therefore, the present invention improves the loop structure speed of the processor and enhances the overall operational performance of the system.

In order to make the aforementioned and other aspects, features and advantages of the present invention comprehensible, preferred embodiments accompanied with figures are described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 shows a data processing apparatus for loop structure according to an embodiment of the present invention.

FIG. 2 shows a data processing apparatus for loop structure according to another embodiment of the present invention.

FIG. 3 shows a data processing apparatus for loop structure according to still another embodiment of the present invention.

FIG. 4 is a flow chart of a method for processing the loop structure data according to an embodiment of the present invention.

### DESCRIPTION OF EMBODIMENTS

FIG. 1 shows a data processing apparatus for loop structure according to an embodiment of the present invention. The data processing apparatus for loop structure 130 includes a loop detector 131 and a fast memory device 132. The loop detector 131 is coupled to the processor 110 for detecting whether or not the processor 110 performs a loop structure. When it is determined that the processor 110 performs the loop structure, the loop detector 131 outputs a control signal CT, and according to the control signal CT, the data processing apparatus for loop structure 130 stores a loop structure data corresponding to the loop structure in the fast memory device 132 for the processor 110 to perform the loop structure.

The fast memory device 132 can be, for example, a static random access memory (SRAM) or a dynamic random access memory (DRAM). Compared with the flash memory or other storage devices such as a hard disc or an optical disc, SRAM and DRAM are memories with higher accessing speed, and thus the speed of the processor 110 reading the desired loop structure data through the SRAM and DRAM is much higher than that of the processor 110 reading the required loop structure data through the flash memory. Thus, in this embodiment, when the processor 110 performs the loop structure, the desired loop data is read through the fast memory device 132, so as to avoid delaying the reading of data and accelerate the operation speed of the system. Furthermore, since the fast memory device 132 is only responsible for storing the loop data, a memory device with a proper capacity is required to be disposed only, thus saving a memory device with large capacity and reducing the design cost.

It should be mentioned that although several possible configurations of the data processing apparatus for loop structure have been illustrated in the above embodiment, it would be known to those of ordinary skill in the art that each manufacturer has a different design of the processor 110, the fast memory device 132, and the loop detector 131, and the application of the present invention is not limited to those possible configurations. In other words, it conforms to spirits of the present invention that when the processor 110 performs the loop structure, the loop structure data corresponding to the loop structure is stored in the fast memory device 132 for the processor 110 to perform the loop structure.

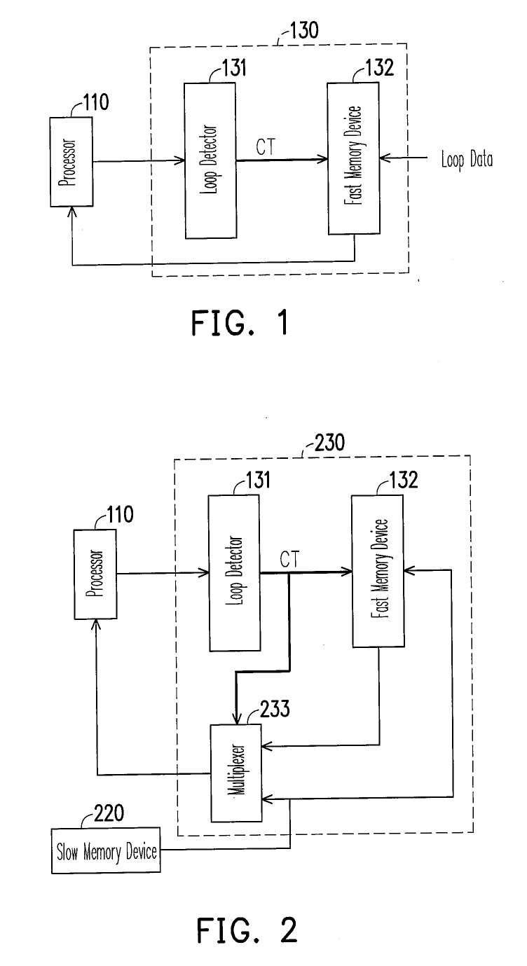

FIG. 2 shows a data processing apparatus for loop structure according to another embodiment of the present invention. The data processing apparatus for loop structure 230 includes the loop detector 131, the fast memory device 132, and a multiplexer 233. The loop detector 131 is coupled to the processor 110 for detecting whether or not the processor 110 performs the loop structure. The multiplexer 233 is coupled between the fast memory device 132 and a slow memory device 220. The multiplexer 233 selects one of the fast memory device 132 and the slow memory device 220 according to the control signal CT output by the loop detector 131 to provide the loop structure data to the processor 110.

When it is determined that the processor 110 performs the loop structure, the fast memory device 131 provides the loop structure data to the processor 110 when the fast memory device 131 has the loop structure data. When the fast memory device 131 does not store the loop structure data, the slow memory device 220 provides the loop structure data to the processor 110 and duplicates the loop structure data into the fast memory device 131. In this embodiment, the loop structure data is pre-stored in the slow memory device 220. Therefore, after it is detected that the processor 110 is required to perform the loop structure, the loop data is duplicated from the slow memory device 220 into the fast memory device 132. After the duplication is completed, the processor 110 reads the desired loop data directly from the fast memory device 132 to continue performing the loop structure. Since the fast memory device 132 has a higher data-accessing speed, the wait time of the processor 110 is reduced, thereby enhancing the operational performance of the system. In another embodiment of the invention, the loop structure data could be stored in a buffer when the processor performs the loop structure, and then duplicates the loop structure data into the fast memory device from the buffer.

The slow memory device 220 can be a flash memory or a storage device, such as a hard disc. In a general system application, BIOS is, for example, also a flash memory, such as a series flash or a parallel flash.

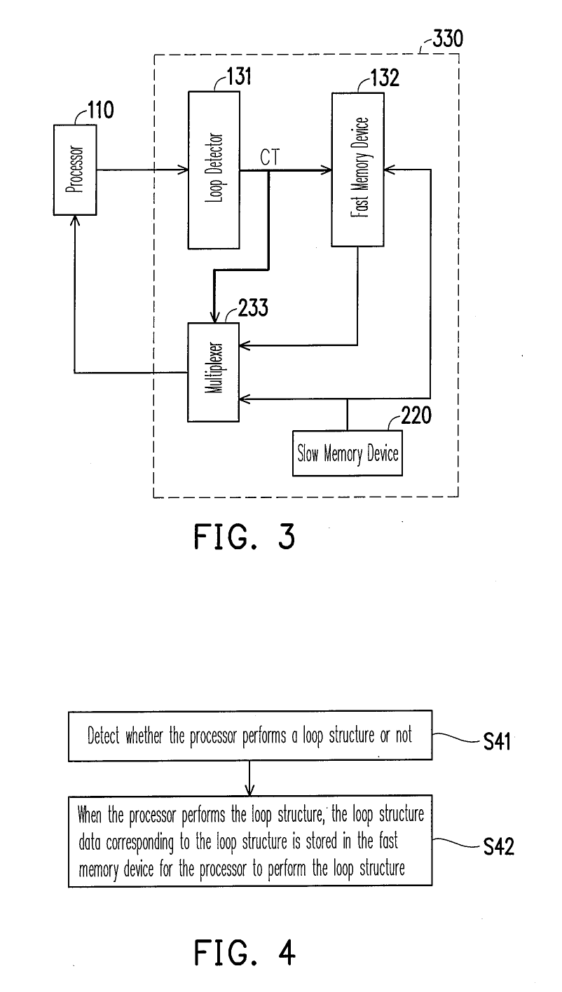

FIG. 3 shows a data processing apparatus for loop structure according to still another embodiment of the present invention. The main difference between FIG. 3 and FIG. 2 lies in that the data processing apparatus for loop structure 330 includes the slow memory device 220. In other words, the data processing apparatus for loop structure 330 in FIG. 3 is directly applied in the processor without a memory for storing the operation data required by the processor and enhancing the operation speed of the processor, thereby realizing a system with excellent loop data processing performance. The detailed operations of the embodiment of FIG. 3 are the same as that of the embodiment of FIG. 2, and will not be described herein again.

In the above embodiment, the loop structure can be divided into a pre-test loop and a post-test loop. Taking the embodiment of FIG. 2 as an example, if the processor 110 performs the post-test loop structure, the loop detector 131 detects that the processor 110 performs the loop structure after a first batch of loop structure data read from the slow memory device 220 by the processor 110. Then, the loop structure data is duplicated into the fast memory device 132, so that the processor 110 reads the desired loop structure data from the fast memory device 132.

If the processor 110 performs the pre-test loop structure, the loop detector 131 detects and outputs a control signal CT before the processor 131 performs the loop structure. Therefore, the data processing apparatus for loop structure 330 first duplicates the loop structure data into the fast memory device 132 for the processor 110 to read the desired loop structure data from the fast memory device 132. For example, if the processor 110 is an 8051 microprocessor, the loop detector 131 detects whether the program code of the processor 110 has a “DJNZ/CJNE tag”, so as to determine whether the processor 110 performs the loop structure. If the processor 110 is an 8086 microprocessor, the loop detector 131 detects whether the program code of the processor 110 has a “DEC CX/JNZ tag”, so as to determine whether the processor 110 performs the loop structure or not.

Furthermore, if the processor 110 is an 80×86 microprocessor, the loop specific instruction of the program code of the processor 110 is used to determine whether the processor 110 performs the loop structure or not. For example, the loop specific instruction can be a “LOOP”, “LOOPZ”, “LOOPE” instruction that are commonly used in C language or a combination thereof, which are selected depending upon the program designing. Those of ordinary skill in the art can define the loop specific instructions freely according to the adopted systems and processors which are within the scope of the present invention.

Therefore, regardless of whether the above loop structure is a post-test loop or a pre-test loop, the present invention can be used to achieve the purposes of improving the loop structure speed of the processor and enhancing the overall operational performance of the system. Furthermore, those of ordinary skill in the art should know that the data accessing and duplication of the fast memory device 131 and the slow memory device 220 can be achieved by a memory controller or can be integrated into the data processing apparatus for loop structure 330, and the details will not be described herein again.

FIG. 4 is a flow chart of a method for processing the loop structure data according to an embodiment of the present invention. Referring to the embodiment of FIG. 1 together, in Step S41, the loop detector 131 detects whether or not the processor 110 performs a loop structure. Next, in Step S42, when the processor 110 performs the loop structure, a loop structure data corresponding to the loop structure is stored in the fast memory device 132 for the processor 110 to perform the loop structure.

In Step S42, when the loop structure data corresponding to the loop structure is stored into the fast memory device, if the fast memory device has the loop structure data, the fast memory device provides the loop structure data to the processor. If the fast memory device does not store the loop structure data, the slow memory device provides the loop structure data to the processor, and then duplicates the loop structure data into the fast memory device. In another embodiment of the invention, the loop structure data could be stored in a buffer when the processor performs the loop structure, and then duplicates the loop structure data into the fast memory device from the buffer in Step S42.

According to the teachings of the loop data processing apparatus in the above embodiments, those of ordinary skill in the art can easily understand the detailed operations of Step S42, which will not be described herein again. In the embodiment of FIG. 4, other detailed operations of the above processing method have been illustrated in the above descriptions of FIG. 1-FIG. 3, which can be easily deduced by those of ordinary skill in the art with the reference to the disclosure of the present invention, and the details will not be described herein again.

To sum up, in the present invention, when the processor performs the loop structure, the desired loop data is duplicated into the fast memory device, for example, DRAM, SRAM, etc. Therefore, the processor directly reads the desired loop data from the fast memory device, thereby improving the loop structure speed of the processor and enhancing the overall operational performance of the system.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A data processing apparatus for loop structure for enhancing an operational performance of a processor, comprising:
a fast memory device; and
a loop detector, coupled to a processor to detect whether or not the processor performs a loop structure;
wherein when it is detected that the processor performs the loop structure, the loop detector outputs a control signal, and the data processing apparatus for loop structure stores a loop structure data corresponding to the loop structure in the fast memory device for the processor to perform the loop structure according to the control signal.

2. The data processing apparatus for loop structure as claimed in claim 1, wherein the loop structure data is originally stored in a slow memory device.

3. The data processing apparatus for loop structure as claimed in claim 2, further comprising:
a multiplexer, coupled to the fast memory device and the slow memory device, for selecting one of the fast memory device and the slow memory device according to the control signal to provide the loop structure data to the processor;
wherein when the processor performs the loop structure, the fast memory device provides the loop structure data to the processor if the fast memory device has the loop structure data; and the slow memory device provides the loop structure data to the processor, and duplicates the loop structure data into the fast memory device if the fast memory device does not store the loop structure data.

4. The data processing apparatus for loop structure as claimed in claim 2, wherein the slow memory device comprises a series flash.

5. The data processing apparatus for loop structure as claimed in claim 1, wherein the fast memory device comprises a static random access memory or a dynamic random access memory.

6. The data processing apparatus for loop structure as claimed in claim 1, wherein the loop structure data is stored in a buffer when the processor performs the loop structure, and then duplicates the loop structure data into the fast memory device from the buffer.

7. The data processing apparatus for loop structure as claimed in claim 1, further comprising:
a slow memory device, for storing the loop structure data; and
a multiplexer, coupled to the fast memory device and the slow memory device, for selecting one of the fast memory device and the slow memory device according to the control signal to provide the loop structure data to the processor;
wherein when the processor performs the loop structure, the fast memory device provides the loop structure data to the processor if the fast memory device has the loop structure data; and the slow memory device provides the loop structure data to the processor, and duplicates the loop structure data into the fast memory device if the fast memory device does not store the loop structure data.

8. The data processing apparatus for loop structure as claimed in claim 1, wherein the processor comprises an 8051 microprocessor.

9. The data processing apparatus for loop structure as claimed in claim 8, wherein the loop detector detects whether or not the program code operated by the processor has a “DJNZ/CJNE tag”, so as to determine whether or not the processor performs a loop structure.

10. The data processing apparatus for loop structure as claimed in claim 1, wherein the processor comprises an 8086 microprocessor.

11. The data processing apparatus for loop structure as claimed in claim 10, wherein the loop detector detects whether or not the program code operated by the processor has a “DEC CX/JNZ tag”, so as to determine whether or not the processor performs a loop structure.

12. The data processing apparatus for loop structure as claimed in claim 1, wherein the processor is an 80×86 microprocessor.

13. The data processing apparatus for loop structure as claimed in claim 12, wherein the loop detector detects whether or not the program code operated by the processor has a “LOOP”, “LOOPZ”, or “LOOPE” instruction or a combination thereof, so as to determine whether or not the processor performs a loop structure.

14. A method for processing a loop structure data, comprising:
detecting whether or not a processor performs a loop structure; and
when it is detected that the processor performs the loop structure, a loop structure data corresponding to the loop structure is stored in a fast memory device for the processor to perform the loop structure.

15. The method for processing the loop structure data as claimed in claim 14, wherein the loop structure data is stored in a slow memory device.

16. The method for processing the loop structure data as claimed in claim 15, wherein during the step of storing the loop structure data corresponding to the loop structure in the fast memory device, the fast memory device provides the loop structure data to the processor when the fast memory device has the loop structure data; and
the slow memory device provides the loop structure data to the processor and duplicates the loop structure data into the fast memory device when the fast memory device does not store the loop structure data.

17. The method for processing the loop structure data as claimed in claim 14, wherein the processor comprises an 8051 microprocessor.

18. The method for processing the loop structure data as claimed in claim 17, wherein the step of detecting whether or not the processor performs the loop structure comprises:
detecting “DJNZ/CJNE tag” of the program code operated by the processor, so as to determine whether or not the processor performs the loop structure.

19. The method for processing the loop structure data as claimed in claim 14, wherein the processor comprises an 8086 microprocessor.

20. The method for processing the loop structure data as claimed in claim 19, wherein the step of detecting whether or not the processor performs the loop structure comprises:
detecting “DEC CX/JNZ” tag of the program code operated by the processor, so as to determine whether or not the processor performs the loop structure.

21. The method for processing the loop structure data as claimed in claim 14, wherein the processor comprises an 80×86 microprocessor.

22. The method for processing the loop structure data as claimed in claim 14, wherein the step of detecting whether or not the processor performs the loop structure comprises:
detecting a loop specific instruction of the program code operated by the processor, so as to determine whether or not the processor performs the loop structure.

23. The method for processing the loop structure data as claimed in claim 22, wherein the loop specific instruction is located before the program code operated by the processor starts to perform the loop structure.

24. The method for processing the loop structure data as claimed in claim 22, wherein the loop specific instruction is located after the program code operated by the processor starts to perform the loop structure.

25. The method for processing the loop structure data as claimed in claim 22, wherein the loop specific instruction comprises a “LOOP”, “LOOPZ”, or “LOOPE” instruction or a combination thereof.

26. The method for processing the loop structure data as claimed in claim 14, wherein the loop structure data is stored in a buffer when the processor performs the loop structure, and then duplicates the loop structure data into the fast memory device from the buffer.
